(19) United States
(12) Patent Application Publication
(10) Pub. No.: US 2024/0177115 A1
(43) Pub. Date: May 30, 2024

(54) Software Defined Community Cloud

(71) Applicant: Google LLC, Mountain View, CA (US)

(72) Inventors: Christopher William Johnson, San Francisco, CA (US); Jason Edward Callaway, Frederick, MD (US); Anthony Michael Carnevale, San Diego, CA (US); Timothy Matthew Dierks, Brooklyn, NY (US); Omkhar Arasaratnam, New York City, NY (US)

(73) Assignee: Google LLC, Mountain View, CA (US)

(21) Appl. No.: 18/059,239

(22) Filed: Nov. 28, 2022

(51) Int. Cl. G06Q 10/10; H04L 9/40

(52) U.S. Cl. CPC G06Q 10/103; H04L 63/20

(57) ABSTRACT

A method for implementing software-defined community clouds includes receiving, from a first requestor, a first access request requesting access to a first project of a plurality of projects. Each project includes project data governed by a compliance regime that enforces compliance requirements. The method includes, for each compliance requirement, determining that the first access request satisfies the compliance requirement. The method includes, based on determining that the first access request satisfies compliance requirements, granting the first requestor access to the first project. The method includes receiving, from a second requestor, a second access request requesting access to a second project and determining that the second access request fails to satisfy one of the one of the compliance requirements. The method also includes, based on determining that the second access request fails to satisfy one of the compliance requirements, denying the second requestor access to the second project.

### TECHNICAL FIELD

This disclosure relates to software-defined community clouds.

### BACKGROUND

To address the cloud computing needs of highly regulated customers such as governmental entities, cloud service providers typically employ a traditional “government cloud,” or a “community cloud.” A community cloud is commonly defined as cloud infrastructure that is provisioned for exclusive use by a specific community of consumers from organizations that have shared concerns (e.g., mission, security requirements, policy, and/or compliance considerations). The community cloud may be owned, managed, and/or operated by one or more of the organizations in the community, a third party, or any combination thereof, and it may exist on or off premises. These community clouds are typically deployed in separate physical buildings from other public cloud assets of the cloud service provider and rely on physical separation as the primary means of establishing a security perimeter. A few benefits of the community cloud model include that all community customers are under the same security controls, easy support for attributes such as geographical location or citizenship with limited physical and/or logical access to resources, simple data locality, sovereignty based on the location of the data centers, and a clearly defined perimeter security model (i.e., a “castle wall”).

### SUMMARY

One aspect of the disclosure provides a computer-implemented method for providing software-defined community clouds that when executed by data processing hardware of a distributed computing system, causes the data processing hardware to perform operations. The operations include receiving, from a first requestor, a first access request requesting access to a first project of a plurality of projects hosted by the distributed computing system. Each project of the plurality of projects includes respective project data governed by a respective compliance regime. Each respective compliance regime enforces one or more respective compliance requirements for accessing the respective project data. The operations include, for each respective compliance requirement of the one or more respective compliance requirements of the first project, determining that the first access request satisfies the respective compliance requirement. The operations also include, based on determining that the first access request satisfies each respective compliance requirement of the one or more respective compliance requirements, granting the first requestor access to the first project. The operations include receiving, from a second requestor, a second access request requesting access to a second project of the plurality of projects and, for one of the one or more respective compliance requirements of the second project, determining that the second access request fails to satisfy the one of the one or more respective compliance requirements. Based on determining that the second access request fails to satisfy the one of the one or more respective compliance requirements of the second project, the operations include denying the second requestor access to the second project.

Implementations of the disclosure may include one or more of the following optional features. In some implementations, each project includes a plurality of infrastructure primitives, each infrastructure primitive representing an atomic unit of capacity of the distributed computing system. Each infrastructure primitive may include one of a virtual machine, a persistent storage disk, or a storage bucket. In some of these example, each project of the plurality of projects is isolated from the infrastructure primitives of each other project.

In some implementations, determining that the first access request satisfies the respective compliance requirement includes applying a zero trust access control policy. In some of these implementations, the zero trust access control policy requires each access request include two-factor authentication and an access justification. Determining that the first access request satisfies the respective compliance requirement may include determining that the access justification of the first access request is a valid justification for the requested access. In some of these implementations, the zero trust access control policy is dynamic based on an observable state of an identity of the first requestor, an observable state of the first project, and one or more environmental attributes.

In some examples, the distributed computing system provides a community cloud environment for the first requestor and the second requestor. The first requestor optionally includes a first user of a first organization and the second requestor optionally includes a second user of a second organization different from the first organization. The first requestor may be an administrator of the first project. Each respective compliance regime, in some implementations, specifies at least one of a geographical region for storage of the respective project data, an encryption requirement for the respective project data, or a usage requirement constraining use of the respective project data.

Another aspect of the disclosure provides a system for software-defined community clouds. The system includes data processing hardware and memory hardware in communication with the data processing hardware. The memory hardware stores instructions that when executed on the data processing hardware cause the data processing hardware to perform operations. The operations include receiving, from a first requestor, a first access request requesting access to a first project of a plurality of projects hosted by the distributed computing system. Each project of the plurality of projects includes respective project data governed by a respective compliance regime. Each respective compliance regime enforces one or more respective compliance requirements for accessing the respective project data. The operations include, for each respective compliance requirement of the one or more respective compliance requirements of the first project, determining that the first access request satisfies the respective compliance requirement. The operations also include, based on determining that the first access request satisfies each respective compliance requirement of the one or more respective compliance requirements, granting the first requestor access to the first project. The operations include receiving, from a second requestor, a second access request requesting access to a second project of the plurality of projects and, for one of the one or more respective compliance requirements of the second project, determining that the second access request fails to satisfy the one of the one or more respective compliance requirements. Based on determining that the second access request fails to satisfy the one of the one or more respective compliance requirements of the second project, the operations include denying the second requestor access to the second project.

This aspect may include one or more of the following optional features. In some implementations, each project includes a plurality of infrastructure primitives, each infrastructure primitive representing an atomic unit of capacity of the distributed computing system. Each infrastructure primitive may include one of a virtual machine, a persistent storage disk, or a storage bucket. In some of these example, each project of the plurality of projects is isolated from the infrastructure primitives of each other project.

In some implementations, determining that the first access request satisfies the respective compliance requirement includes applying a zero trust access control policy. In some of these implementations, the zero trust access control policy requires each access request include two-factor authentication and an access justification. Determining that the first access request satisfies the respective compliance requirement may include determining that the access justification of the first access request is a valid justification for the requested access. In some of these implementations, the zero trust access control policy is dynamic based on an observable state of an identity of the first requestor, an observable state of the first project, and one or more environmental attributes.

In some examples, the distributed computing system provides a community cloud environment for the first requestor and the second requestor. The first requestor optionally includes a first user of a first organization and the second requestor optionally includes a second user of a second organization different from the first organization. The first requestor may be an administrator of the first project. Each respective compliance regime, in some implementations, specifies at least one of a geographical region for storage of the respective project data, an encryption requirement for the respective project data, or a usage requirement constraining use of the respective project data.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for providing software-defined community clouds.

FIG. 2 is a schematic view of infrastructure primitives.

FIG. 3 is a schematic view of exemplary components of the system of FIG. 1.

FIG. 4 a flowchart of an example arrangement of operations for a method of providing software-defined community clouds.

FIG. 5 is a schematic view of an example computing device that may be used to implement the systems and methods described herein.

Like reference symbols in the various drawings indicate like elements.

### DETAILED DESCRIPTION

To address the cloud computing needs of highly regulated customers such as governmental entities, cloud service providers typically employ a traditional “government cloud,” or a “community cloud.” A community cloud is commonly defined as cloud infrastructure that is provisioned for exclusive use by a specific community of consumers from organizations that have shared concerns (e.g., mission, security requirements, policy, and/or compliance considerations). The community cloud may be owned, managed, and/or operated by one or more of the organizations in the community, a third party, or any combination thereof, and it may exist on or off premises. These community clouds are typically deployed in separate physical buildings from other public cloud assets of the cloud service provider and rely on physical separation as the primary means of establishing a security perimeter. A few benefits of the community cloud model include that all community customers are under the same security controls, easy support for attributes such as geographical location or citizenship with limited physical and/or logical access to resources, simple data locality, sovereignty based on the location of the data centers, and a clearly defined perimeter security model (i.e. a “castle wall”).

While this physical separation-based model offers key benefits in simplicity and segregation, there are downsides. The perimeter security model, also referred to as a “castle wall model,” does not actually yield enhanced security or manageability. For example, a commonly articulated risk includes “exploitation of vulnerabilities in virtualization technologies” which describes a common fallacy in enterprise security: designing around virtual machine (VM) breakouts. Due to the difficulty of crafting such an exploit, and the infrequency of viable proof of concept exploit code, designing around VM breakouts is not efficient or effective. Not only are these attacks infrequently seen in the wild, multiple mitigations may be put in place, including, but not limited to, emulation and hypervisor hardening. When combined with monitoring logs confirming the rareness of VM breakouts, the likelihood of a CSP customer experiencing a breach due to a peer VM breakout is statistically insignificant.

The importance of the VM breakout threat model is even further diminished by the fact that, even if such an exploit existed, the exploit could still be used by a malicious community member or an attacker that had compromised a community system. Moreover, there is a negative social engineering aspect to castle walls. The perception of enhanced security behind the castle wall can result in a false sense of security by members of the community of interest (COI). In other words, if an administrator or developer believes in the safety of the castle walls, the administrator or developer may not pay as much attention to security, instead falsely believing that castle walls provide more protection than they actually do. There is no guarantee that community organizations and personnel will not engage in malicious activity, i.e., the insider threat model. Furthermore, if a community cloud workload is compromised by an external attacker, that attacker is then inside the castle wall and the benefits of a narrowly scoped COI are greatly diminished. Once inside the castle wall, the attacker can attempt a VM breakout and privilege escalation on the host system, thereby nullifying the benefits of a siloed virtualization stack. Malicious members of the COI may also attempt such a breakout.

With VM breakouts technically mitigated, implementations herein include methods and systems for a software-defined community cloud controller that uses a combination of features referred to in aggregate as “assured workloads” to deliver benefits of a community cloud (e.g., scalability, cost, etc.) in a modern architecture. With assured workloads, the controller may define communities around a shared mission, security and compliance requirements, and/or policy. The controller may separate community projects from other community projects and add or remove capabilities from a community's boundary with policy-controlled and audited configuration changes as opposed to managing change across an air-gap (as is common among conventional community clouds). The controller and system make use of zero trust principles for people and systems accessing the system. These controls reduce insider risk in addition to complying with common foreign access requirements. This ensures that no implicit trust is granted to resources (including users, devices, applications, services, assets, etc.), based on physical location, network location, and/or asset ownership. Authentication and authorization may be discrete functions that must be performed on a per-request basis, before access to resources is granted. That is, the system may require authentication and authorization for any access requests or related data including person and nonperson identities, credentials, access management, operations, endpoints, hosting environment(s), and/or interconnecting infrastructure. Put another way, implementations herein focus on protecting resources, not network segments.

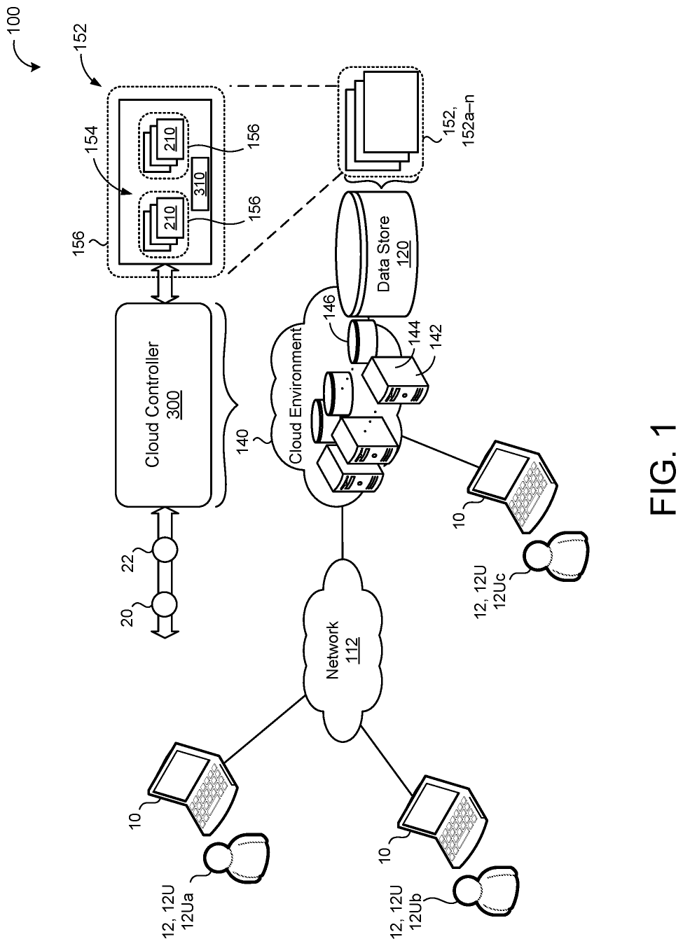

Referring to FIG. 1, in some implementations, an example community cloud system 100 includes a remote system 140 in communication with one or more user devices 10 via a network 112 (e.g., via a local network or the Internet). The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). A data store 150 (i.e., a remote storage device) may be overlain on the storage resources 150 to allow scalable use of the storage resources 146 by one or more of the clients (e.g., the user devices 10) or the computing resources 142.

The data store 150 stores one or more projects 152, 152a-n. Each project 152 is an isolated, logical grouping of infrastructure primitives 210. As discussed in more detail below, each infrastructure primitive 210 represents an atomic unit of capacity of the system 140 (e.g., a VM, a persistent disk, a storage bucket, etc.). Using the infrastructure primitives 210, each project 152 stores and maintains respective project data 154. The project data 154 refers to any data under control of the project 152, such as code, libraries, databases, documents, images, metadata, etc. Each project 152 and the respective project data 154 is governed by a respective compliance regime 156. The compliance regime 156 enforces one or more respective compliance requirements 310. The compliance requirements 310 establish controls on the project 152 and project data 154. For example, the compliance requirements 310 impose authorization controls (i.e., who is allowed to read data, write data, etc.), encryption controls (e.g., encryption requirements for data at rest and for data in transit), geographic storage control (e.g., which geographic zones the data must be stored or replicated at), limitation controls (e.g., whether the project data 154 may be used for a particular purpose, such as machine learning), etc. The compliance regime 156 may ensure that the project data 154 of the project 152 is maintained and accessed in accordance with one or more regulatory requirements (e.g., governmental regulations). For example, the compliance requirements 310 of a project 152 ensure that a subset of the project data 154 may not be accessed by any person (e.g., only automated systems have access to the subset of the project data 154) while other compliance requirements 310 of the project 152 ensure that a different subset of the project data 154 may only be accessed by person of within a specified geographical location and/or have a specified citizenship.

The remote system 140 executes a cloud controller 300. The cloud controller 300 interfaces with the projects 152 and ensures that all access to each project 152 satisfies the corresponding compliance regime 156 (i.e., the compliance requirements 310 of the compliance regime 156). To this end, the cloud controller 300 receives, from a requestor 12, a request 20 to access (i.e., read and/or write) the project data 154 for a respective project 152. In some examples, the requestor 12 is an external user 12, 12U (i.e., the user 12U accesses the remote system 140 via an external or public network 112) or an internal user 12U (i.e., the user 12U accesses the remote system directly via, for example, a private network (not shown)) using a respective user device 10. In other examples, the requestor 12 is a process or program executing on the remote system 140 or other remote entity. The user device 10 may correspond to any computing device, such as a desktop workstation, a laptop workstation, or a mobile device (e.g., a smart phone or tablet). In some examples, the requestor 12 is a program executing on the remote system 140 or another remote device (not shown). For example, an automated program of the remote system 140 may issue a request 20 to access the project data 154 to alter the provisioning of the project 152 (e.g., by adding or removing infrastructure primitives 210 to the project 152).

The cloud controller 300, upon receiving the request 20 for a respective project 152, determines, for each respective compliance requirement 310 of the respective project 152, whether the request 20 satisfies the respective compliance requirement 310. That is, as discussed in more detail below, the cloud controller 300 determines that each and every compliance requirement 310 is satisfied prior to granting access to the project data 154. For example, a first user 12U, 12Ua sends an access request 20 to access project data 154 of a first project 152. Upon determining that the access request 20 and/or the first user 12Ua satisfies each and every compliance requirement 310 of the compliance regime 156 governing the first project 152, the cloud controller 300 grants the first user 12Ua the requested access. Similarly, a second user 12U, 12Ub may send an access request 20 requesting access to a second project 152. In this example, the access request 20 and/or the second user 12Ub fail to satisfy one or more of the compliance requirements 310 of the compliance regime 156 governing the second project 152, and the cloud controller 300 denies or rejects the requested access of the second user 12Ub. In some examples, the cloud controller 300 provides a response 22 indicating a status of the access request 20. For example, the response 22 indicates whether the access request 20 was approved or denied, whether additional information is needed, etc.

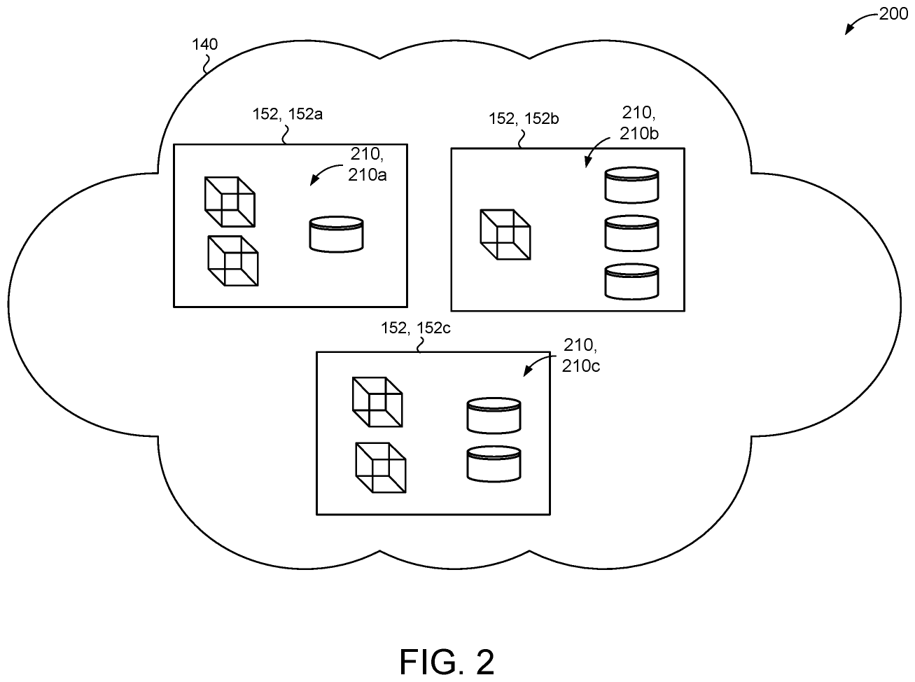

Referring now to FIG. 2, each project is populated by logical grouping of infrastructure primitives 210. Each infrastructure primitive 210 represents any atomic unit of capacity (e.g., processing capacity, storage capacity, etc.) of the remote system 140. For example, the infrastructure primitives 210 represent a VM, a persistent disk, a storage bucket, etc. In some implementations, each project 152 is a “global resource” that may be assigned infrastructure primitives 210 from any region or zone of the distributed remote system 140.

Each project 152 may be, by default, isolated from low-level resources (e.g., hypervisors, blocks from a blockstore, etc.) of each other project 152. Thus, when a project is created/generated, the infrastructure primitives 210 that are assigned to the project 152 are scoped to only that project 152. For example, when a persistent disk is assigned to a respective project 152, no other project 152 may access that persistent disk in any manner while the persistent disk is scoped or assigned to the respective project 152. This scoping of infrastructure primitives 210 effectively creates an “enclave” per project 152. In this manner, each project 152 may be viewed effectively as a private cloud with isolated infrastructure primitives 210. When the projects 152 are overlaid with the compliance regimes 156 and compliance requirements 310 that constrain, for example, data residency, support personnel attributes (e.g., citizenship, location, etc.), and security controls common to community of interest, each project 152 becomes a software-defined community cloud environment for each requestor 12 (e.g., a user 12U) within the scope of a project 152 (i.e., the community of interest).

In the example of FIG. 2, a first project 152, 152a includes a first set of infrastructure primitives 210, 210a. Here, the first set of infrastructure primitives 210a includes two VMs and a persistent disk. A second project 152, 152b includes a second set of infrastructure primitives 210, 210b that includes a single VM and three persistent disks. A third project 152, 152c similarly includes a third set of infrastructure primitives 210, 210c and includes two VMs and two persistent disks. Each infrastructure primitive 210 is “assigned” to only a single project 152 and in that way remains isolated from other projects 152 (and respective compliance regimes 156).

Referring back to FIG. 1, in some implementations, the cloud controller 300 applies a zero trust access policy to each and every access request 20 received from requestors 12. That is, the cloud controller 300 requires all requestors 12, whether originating from within the remote system 140 (e.g., an internal network) or external to the remote system 140, be authorized and authenticated in the same manner. That is, with regards to security, the cloud controller 300 does not acknowledge a traditional network edge. In the example of FIG. 1, a user 12U, 12Uc is an administrator of the remote system 140 with internal access (e.g., via a private network). Regardless, of this status, the user 12Uc is subject to the same access controls imposed by the compliance regimes 156 as external users 12Ua-b. The external users 12Ua-b may be from the same organization or different organizations that, due to overlapping or aligning missions or goals, are governed by the same compliance regime 156 (e.g., a community cloud). In some examples, at least one compliance requirement 310 is applicable to only a subset of requestors 12. For example, some compliance requirements 310 are only applicable to external users 12U while other compliance requirements 310 are only applicable to administrators or internal users 12U. Application of the compliance requirements 310 may be granular. That is, compliance requirements may be individually applies to each “data block” of the project 152 and to each requestor 12 individually.

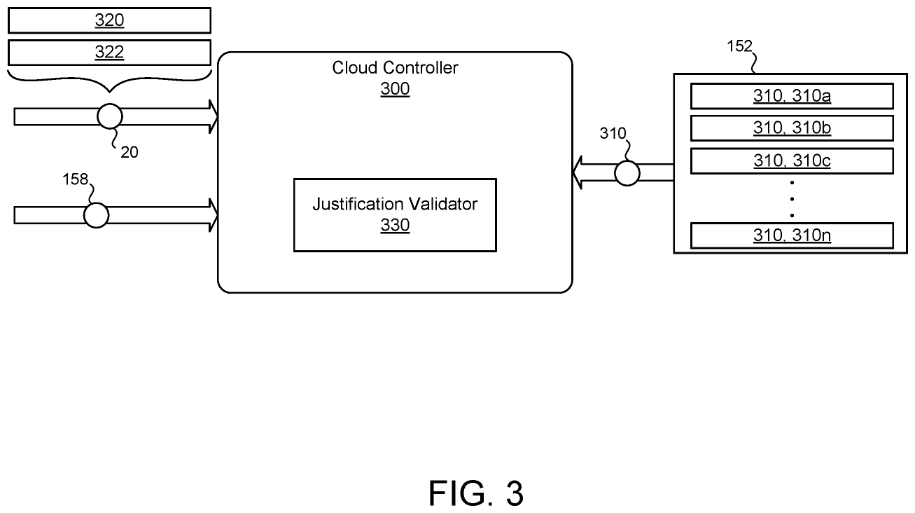

Referring now to FIG. 3, in some examples, the cloud controller 300 requires each and every access request 20 (e.g., from external users 12U, from internal users 12U or administrator, and from programs or processes) include a multi-factor authentication response/token 320 (e.g., two-factor authentication) and an access justification 322. The multi-factor authentication response 320 may include any code, response, token, etc. that demonstrates possession of something only the requestor 12 has. The access justification 322 represents a reason or rationale that the requestor 12 needs access to the project data 154. The cloud controller 300, in some examples, includes a justification validator 330 that determines whether the received access justification 322, based on one or more of the compliance requirements 310 of the project 152, is valid for both the requestor 12 requesting access and valid for the project data 154 to be accessed by the requestor 12. Each respective requestor 12 (e.g., each user 12U) may have a list of justifications valid for the respective requestor 12 and each respective block of project data 154 may have a list of justifications that are valid for the respective block of project data 154.

The access request 20 may include any other information relevant to authenticating and/or validating the requestor 12. For example, the access request 20 includes additional information used to identify the requestor 12. The cloud controller 300 may use the identity of the requestor 12 to determine which compliance requirements 310 are applicable to the requestor 12. For example, when the requestor 12 is an administrator user 12U, the cloud controller determines that a compliance requirement 310 specifying that all administrators have a particular citizenship is applicable to the requestor 12, and ensures that the compliance requirement 310 is satisfied prior to granting access. In some examples, the cloud controller 300 accesses additional data (e.g., from an internal or external database, from the project data 154, etc.) to verify the identity of the requestor 12 and/or to determine whether compliance requirements 310 are satisfied. For example, the cloud controller 300 may access a database to determine a citizenship of the requestor 12 or query a network device to determine a geographic location of the requestor 12.

As an example, for a respective project 152, an access justification 322 of provisioning a new infrastructure primitive 210 is a valid access justification 322 for an administrator of the respective project 152, but is not a valid access justification 322 for a regular external client of the respective project 152. On the other hand, the access justification 322 of provisioning a new infrastructure primitive 210 may not be a valid for accessing a block of customer data. The compliance regime 156 and compliance requirements 310 may tailor valid access justifications 322 for individual requestors 12, groups of requestors 12, and/or specific project data 154. When receiving an access request 20, the cloud controller, in some implementations, retrieves the compliance requirements 310 for the respective project 152 and determines whether the multi-factor authentication response 320 and the access justification 322 of the access request 20 are both valid based on a comparison with the compliance requirements 310.

In this way, the remote system 140 provides a zero trust access control policy that is dynamic based on a number of factors. For example, the access control policy is defined dynamically by an observable state of requestor identify (e.g., based on credentials and the multi-factor authentication response 320), the project data 154 requested (e.g., an application, service, client data, etc.), and other behavioral and/or environmental attributes (e.g., a determined location of the requestor 12, a time period when the access request 20 is received, a quantity of access requests 20 received within a threshold period of time, a status of the remote system 140 and/or the infrastructure primitives 210 of the project 152, etc.).

Thus, the system 100 provides software-defined community clouds that dynamically define communities of interest around shared missions, security and compliance requirements, and policy. The system separates or enclaves projects using infrastructure primitives based on disjointed communities of interest. The system may add or remove capabilities from a project's boundary with policy-controlled and audited configuration changes as opposed to managing change across a conventional air-gap.

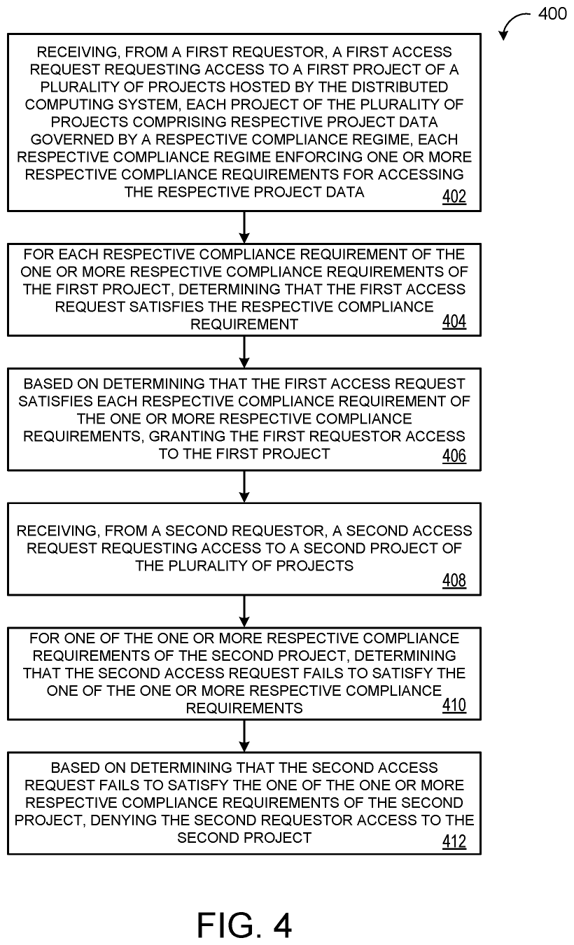

FIG. 4 is a flowchart of an exemplary arrangement of operations for a method 400 of providing software-defined community clouds. The computer-implemented method 400, when executed by data processing hardware 144 of a distributed computing system 140, causes the data processing hardware 144 to perform operations. The method 400, at operation 402, includes receiving, from a first requestor 12 (e.g., a first user 12Ua), a first access request 20 requesting access to a first project 152 of a plurality of projects 152 hosted by the distributed computing system 140. Each project 152 of the plurality of projects 152 includes respective project data 154 governed by a respective compliance regime 156. Each respective compliance regime 156 enforces one or more respective compliance requirements 310 for accessing the respective project data 154.

At operation 404, the method 400 includes, at operation 404, for each respective compliance requirement 310 of the one or more respective compliance requirements 310 of the first project 152, determining that the first access request 20 satisfies the respective compliance requirement 310. Based on determining that the first access request 20 satisfies each respective compliance requirement 310 of the one or more respective compliance requirements 310, the method 400, at operation 406, includes granting the first requestor 12 access to the first project 152. At operation 408, the method 400 includes receiving, from a second requestor 12 (e.g., a second user 12Ub), a second access request 20 requesting access to a second project 152 of the plurality of projects 152. At operation 410, the method 400 includes, for one of the one or more respective compliance requirements 310 of the second project 152, determining that the second access request 20 fails to satisfy the one of the one or more respective compliance requirements 310. The method 400, at operation 412, based on determining that the second access request 20 fails to satisfy the one of the one or more respective compliance requirements 310 of the second project 152, includes denying the second requestor 12 access to the second project 152.

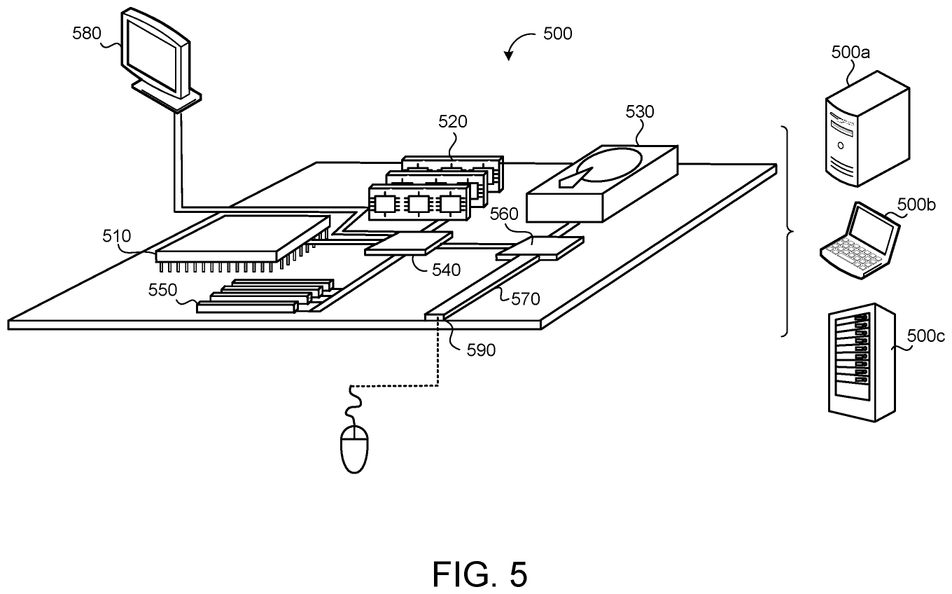

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware of a distributed computing system that causes the data processing hardware to perform operations comprising:
receiving, from a first requestor, a first access request requesting access to a first project of a plurality of projects hosted by the distributed computing system, each project of the plurality of projects comprising respective project data governed by a respective compliance regime, each respective compliance regime enforcing one or more respective compliance requirements for accessing the respective project data;
for each respective compliance requirement of the one or more respective compliance requirements of the first project, determining that the first access request satisfies the respective compliance requirement;
based on determining that the first access request satisfies each respective compliance requirement of the one or more respective compliance requirements, granting the first requestor access to the first project;
receiving, from a second requestor, a second access request requesting access to a second project of the plurality of projects;
for one of the one or more respective compliance requirements of the second project, determining that the second access request fails to satisfy the one of the one or more respective compliance requirements; and
based on determining that the second access request fails to satisfy the one of the one or more respective compliance requirements of the second project, denying the second requestor access to the second project.

2. The method of claim 1, wherein each project comprises a plurality of infrastructure primitives, each infrastructure primitive representing an atomic unit of capacity of the distributed computing system.

3. The method of claim 2, wherein each infrastructure primitive comprises one of:
a virtual machine;
a persistent storage disk; or
a storage bucket.

4. The method of claim 2, wherein each project of the plurality of projects is isolated from the infrastructure primitives of each other project.

5. The method of claim 1, wherein determining that the first access request satisfies the respective compliance requirement comprises applying a zero trust access control policy.

6. The method of claim 5, wherein the zero trust access control policy requires each access request comprise:
two-factor authentication; and
an access justification.

7. The method of claim 6, wherein determining that the first access request satisfies the respective compliance requirement comprises determining that the access justification of the first access request is a valid justification for the requested access.

8. The method of claim 5, wherein the zero trust access control policy is dynamic based on:
an observable state of an identity of the first requestor;
an observable state of the first project; and
one or more environmental attributes.

9. The method of claim 1, wherein the distributed computing system provides a community cloud environment for the first requestor and the second requestor.

10. The method of claim 1, wherein:
the first requestor comprises a first user of a first organization; and
the second requestor comprises a second user of a second organization different from the first organization.

11. The method of claim 1, wherein the first requestor is an administrator of the first project.

12. The method of claim 1, wherein each respective compliance regime specifies at least one of:
a geographical region for storage of the respective project data;
an encryption requirement for the respective project data; or
a usage requirement constraining use of the respective project data.

13. A system comprising:
data processing hardware of a distributed computing system; and
memory hardware in communication with the data processing hardware, the memory hardware storing instructions that when executed on the data processing hardware cause the data processing hardware to perform operations comprising:
receiving, from a first requestor, a first access request requesting access to a first project of a plurality of projects hosted by the distributed computing system, each project of the plurality of projects comprising respective project data governed by a respective compliance regime, each respective compliance regime enforcing one or more respective compliance requirements for accessing the respective project data;
for each respective compliance requirement of the one or more respective compliance requirements of the first project, determining that the first access request satisfies the respective compliance requirement;
based on determining that the first access request satisfies each respective compliance requirement of the one or more respective compliance requirements, granting the first requestor access to the first project;
receiving, from a second requestor, a second access request requesting access to a second project of the plurality of projects;
for one of the one or more respective compliance requirements of the second project, determining that the second access request fails to satisfy the one of the one or more respective compliance requirements; and
based on determining that the second access request fails to satisfy the one of the one or more respective compliance requirements of the second project, denying the second requestor access to the second project.

14. The system of claim 13, wherein each project comprises a plurality of infrastructure primitives, each infrastructure primitive representing an atomic unit of capacity of the distributed computing system.

15. The system of claim 14, wherein each infrastructure primitive comprises one of:
a virtual machine;
a persistent storage disk; or
a storage bucket.

16. The system of claim 14, wherein each project of the plurality of projects is isolated from the infrastructure primitives of each other project.

17. The system of claim 13, wherein determining that the first access request satisfies the respective compliance requirement comprises applying a zero trust access control policy.

18. The system of claim 17, wherein the zero trust access control policy requires each access request comprise:
two-factor authentication; and
an access justification.

19. The system of claim 18, wherein determining that the first access request satisfies the respective compliance requirement comprises determining that the access justification of the first access request is a valid justification for the requested access.

20. The system of claim 17, wherein the zero trust access control policy is dynamic based on:
an observable state of an identity of the first requestor;
an observable state of the first project; and
one or more environmental attributes.

21. The system of claim 13, wherein the distributed computing system provides a community cloud environment for the first requestor and the second requestor.

22. The system of claim 13, wherein:
the first requestor comprises a first user of a first organization; and
the second requestor comprises a second user of a second organization different from the first organization.

23. The system of claim 13, wherein the first requestor is an administrator of the first project.

24. The system of claim 13, wherein each respective compliance regime specifies at least one of:
a geographical region for storage of the respective project data;
an encryption requirement for the respective project data; or
a usage requirement constraining use of the respective project data.
